(19) United States
(12) Patent Application Publication
(10) Pub. No.: US 2020/0325058 A1
(43) Pub. Date: Oct. 15, 2020

(54) BENT GLASS ARTICLES AND METHODS OF MANUFACTURING

(71) Applicant: CORNING INCORPORATED, Corning, NY (US)

(72) Inventors: Steven Roy Burdette, Big Flats, NY (US); Anurag Jain, Painted Post, NY (US); Francisco Javier Moraga, Corning, NY (US); Larry Gene Smith, Tulsa, OK (US); John Christopher Thomas, Elmira, NY (US)

(21) Appl. No.: 16/849,305

(22) Filed: Apr. 15, 2020

Related U.S. Application Data
(60) Provisional application No. 62/834,040, filed on Apr. 15, 2019.

(51) Int. Cl. C03B 23/025

(52) U.S. Cl. CPC C03B 23/0258; C03B 23/0252

(57) ABSTRACT

Various embodiments disclosed relate to an assembly for bending glass. The assembly includes a support extending along an x-direction and a y-direction. The support includes a support first major surface and opposed second major surface. The assembly further includes a bending ring attached to and extending vertically along a z-direction from the support first major surface substantially along an outer perimeter of the support first major surface. The assembly further includes a passive heat element disposed between the support first major surface and a top end of the bending ring.

### CROSS-REFERENCE TO RELATED APPLICATIONS

This application claims the benefit of priority under 35 U.S.C. § 119 of U.S. Provisional Application Ser. No. 62/834,040 filed on Apr. 15, 2019 the content of which is relied upon and incorporated herein by reference in its entirety.

### BACKGROUND

Glass parts used in a vehicle as a windshield, window, or the like often need to be curved to a specific degree before being included in the vehicle. Curving or bending the glass assembly can include exposing the glass part to an amount of heat that will cause the glass part to bend. If the heat applied to the glass part is not controlled, defects may be imparted to the glass part. One defect that can be imparted to the glass part is a “bathtub” effect in which the edge region of the glass part is over-sagged compared to the target shape and the center of the part is flat and under-sagged, resulting in a bathtub like shape. This bathtub effect can be especially pronounced in thin glass parts (e.g., having a thickness less than or equal to about 1.0 mm) as compared to thicker glass parts (e.g., having a thickness in a range of from about 3.2 mm to about 5 mm).

### SUMMARY OF THE DISCLOSURE

Various embodiments disclosed relate to an assembly for bending glass. The assembly includes a support extending along an x-direction and a y-direction. The support includes a support first major surface and opposed second major surface. The assembly further includes a bending ring attached to and extending vertically along a z-direction from the support first major surface substantially along an outer perimeter of the support first major surface. The assembly further includes a passive heat element disposed between the support first major surface and a top end of the bending ring.

Various further embodiments disclosed relate to a method of bending a glass substrate. The method includes actively heating the first major surface of the glass substrate. The method further includes passively heating the opposed second major surface of the glass substrate.

Various further embodiments disclosed relate to a bent glass article formed according to a method including actively heating the first major surface of the glass substrate. The method further includes passively heating the opposed second major surface of the glass substrate.

Various further embodiments disclosed include a vehicle. The vehicle includes a body defining an interior and an opening in communication with the interior. The vehicle further includes a bent glass article disposed in the opening. The bent glass article is formed according to a method including actively heating the first major surface of the glass substrate. The method further includes passively heating the opposed second major surface of the glass substrate.

### BRIEF DESCRIPTION OF THE FIGURES

The drawings illustrate generally, by way of example, but not by way of limitation, various embodiments discussed in the present document.

FIG. 1 is a schematic depiction of an assembly for bending glass, in accordance with various embodiments.

FIG. 2 is a perspective view of a bending station in a furnace of Example 1, in accordance with various embodiments.

FIG. 3 is a perspective view of another bending station in a furnace of Example 1, in accordance with various embodiments.

FIG. 4 is a heat diagram showing a temperature distribution in glass of Example 1, in accordance with various embodiments.

FIGS. 5A-5C are heat diagrams showing a temperature distribution in glass of Example 1, in accordance with various embodiments.

FIGS. 6A-6B are graphs showing time evolution of recorded temperatures in glass of Example 1, in accordance with various embodiments.

FIGS. 7A-7B are graphs showing time evolution of recorded temperatures in glass of Example 1, in accordance with various embodiments.

FIGS. 8A-8B are graphs showing time evolution of recorded temperatures in glass of Example 1, in accordance with various embodiments.

FIGS. 9A-9B are graphs showing power distribution among heaters of Example 1, in accordance with various embodiments.

FIGS. 10A-10B are graphs showing time evolution of recorded temperatures in glass of Example 1, in accordance with various embodiments.

FIGS. 11A-11B are graphs showing time evolution of recorded temperatures in glass of Example 2, in accordance with various embodiments.

FIG. 12 is a graph showing time evolution of recorded temperatures in glass of Example 2, in accordance with various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

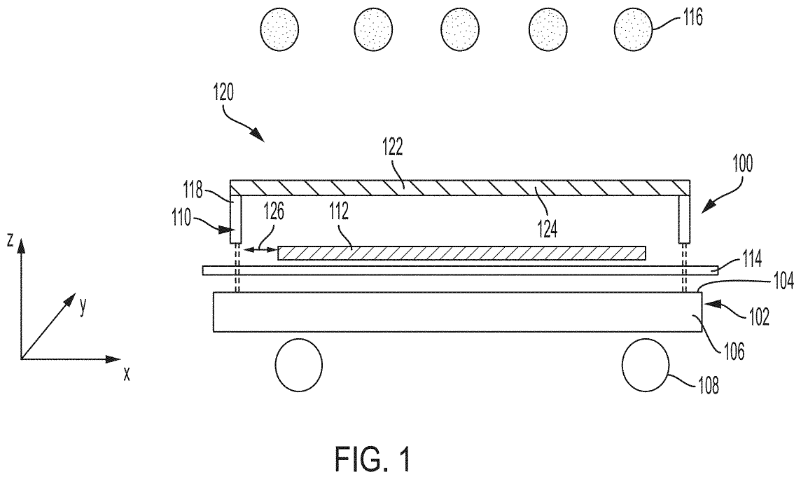

Various embodiments according the present disclosure relate to an assembly for bending glass. FIG. 1 is a schematic depiction of assembly 100 for bending glass. Assembly 100 includes support 102 extending along an x-direction and a y-direction. Support 102 includes support first major surface 104 and opposed second major surface 106. Support 102 can further include wheels 108.

Assembly 100 further includes bending ring 110. Bending ring 110 is attached to support first major surface 104. Bending ring 110 extends vertically along a z-direction from first major surface 104. Bending ring 110 can have a major diameter, measured in either the x-direction or the y-direction. In various embodiments, the profile of the bending ring 110 is substantially commensurate with the profile of first major surface 104. According to various embodiments, bending ring 110 can have a substantially circular or rectangular profile. As shown in FIG. 1, bending ring 110 is substantially linear, but in further embodiments, it can be curved in the z-direction.

Assembly 100 further includes at least one passive heat element disposed between support first major surface 104 and top end 118 of bending ring 110. As shown in FIG. 1, assembly includes respective first and second passive heat elements. The first and second passive heat elements, respectively, are thermal reflector 112 and thermal absorber 114. Although both thermal reflector 112 and thermal absorber 114 are shown, in further embodiments assembly 100 may include either thermal reflector 112 or thermal absorber 114, alone.

Assembly 100 further incudes active heater elements 116. Active heater elements are located above the top end 118 of bending ring 110 in the z-direction. Active heater elements are any element that is capable of generating heat. For example, active heater elements 116 can be furnace coils.

FIG. 1 shows glass substrate 120 in contact with the bending ring 110 of assembly 100. As shown in FIG. 1, glass substrate 120 is in contact with top end 118 of bending ring 110. Glass substrate 120 is capable of being bent when exposed to elevated temperatures. As shown, glass substrate 120 is one ply and includes substrate first major surface 122 and opposed substrate second major surface 124. Substrate second major surface 124 is in contact with top end 118 of bending ring 110.

Although shown as a single ply structure, in various embodiments, glass substrate 120 can include a plurality of glass plies such as a first and second glass ply or any plural number. A thickness of glass substrate 120 or any individual glass ply, measured in the z-direction can be in a range of from about 0.3 mm to about 5 mm, about 1 mm to about 5 mm, about 1.5 mm to about 3 mm, less than, equal to, or greater than about 0.3 mm, 0.5, 1, 1.5, 2, 2.5, 3, 3.5, 4, 4.5, or about 5 mm. Where glass substrate 120 includes multiple plies, the thickness of each ply can be the substantially the same or the thickness of each ply can be substantially different. Glass substrate 120 can include any suitable material glass such as soda lime silicate glass (which can include low iron or iron free soda lime glass), alkali aluminosilicate glass, alkali containing borosilicate glass, alkali aluminophosphosilicate glass, alkali aluminoborosilicate glass, or a mixture thereof. Where glass substrate 120 includes multiple plies, the composition of each ply can be substantially the same or substantially different.

According to various embodiments, support 102, bending ring 110, or both are formed from a heat-resistant material. For example, support 102, bending ring 110, or both can include a metal, a ceramic, a combination thereof, or a composite thereof. Suitable examples of metals include a stainless steel, a nickel alloy or a combination thereof. Suitable examples of stainless steel grades can include SS 304, SS 309, SS 316, SS 347, and SS 405. Suitable examples of nickel alloys include Inconel alloys such as Inconel 600, Inconel 617, Inconel 625, Inconel 690, Inconel 718, and Inconel X-750. Further examples of suitable metals include aluminum, and alloys of a refractory metal such as a molybdenum alloy, tungsten alloy, niobium alloy, tantalum alloy, rhenium alloy, or a combination thereof. Suitable examples of ceramic materials include an aluminosilicate, an alumina, a silica, a silicon carbide, a silicon nitride, an alumina-phosphorous pentoxide, an alumina-bona-silica, a zirconia, a zirconia-alumina, a zirconia-silica, a sol gel, Al₂O₃, barium oxides, boron oxides, silicon oxides, titanium oxides, yttrium oxides, zinc oxides, or mixtures thereof. According to various embodiments, support 102 and bending ring 110 include the same material, but in further embodiments, support 102 and bending ring 110 can include different materials.

In operation, the passive heat elements function to deliver heat to substrate second major surface 124. This is accomplished at least in part by the material(s) and construction of each passive heat element.

With respect to thermal reflector 112, any thermally reflective material can be included. Examples of suitable thermally reflective materials include a metal, a ceramic, or a mixture thereof. According to various embodiments, thermal reflector 112, can be formed entirely from the thermally reflective material or thermal reflector 112 can include a non-thermally reflective substrate with the thermally reflective material disposed thereon to form an external surface of thermal reflector 112.

According to various embodiments of the present disclosure, the thermally reflective material can include a metal, a ceramic, a combination thereof, or a composite thereof. Suitable examples of metals include aluminum, a lustrous elemental metal (e.g., gold or chromium), a stainless steel, a nickel alloy or a combination thereof. Suitable examples of stainless steel grades can include SS 304, SS 309, SS 316, SS 347, and SS 405. Suitable examples of nickel alloys include Inconel alloys such as Inconel 600, Inconel 617, Inconel 625, Inconel 690, Inconel 718, and Inconel X-750. Further examples of suitable metals include alloys of a refractory metal such as a molybdenum alloy, tungsten alloy, niobium alloy, tantalum alloy, rhenium alloy, or a combination thereof.

Suitable examples of ceramic materials include an aluminosilicate, an alumina, a silica, a silicon carbide, a silicon nitride, an alumina-phosphorous pentoxide, an alumina-boria-silica, a zirconia, a zirconia-alumina, a zirconia-silica, a sol gel, Al₂O₃, barium oxides, boron oxides, silicon oxides, titanium oxides, yttrium oxides, zinc oxides, or mixtures thereof. According to various embodiments, support 102 and bending ring 110 include the same material, but in further embodiments, support 102 and bending ring 110 can include different materials. Where present, the ceramic material can be in the form of a blanket, sheet, or board. In some embodiments, thermal reflector 112 can be at least partially coated with a thermally reflective substance such as a lustrous elemental metal (e.g., gold or chromium), a metal oxide, or thermally reflective paint. According to various embodiments, the ceramic material can be present as a blanket or sheet that is at least partially disposed over a portion of any one of thermal reflector 112.

In embodiments where a thermally reflective coating is dispersed over thermal reflector 112, the coating can be dispersed over any range of the total surface area or thermal reflector 112. For example, the thermally reflective coating can be dispersed over about 20% to about 100% surface area of thermal reflector 112, about 50% to about 100% surface area, about 70% to about 90% surface area, less than, equal to, or greater than about 20%, 25, 30, 35, 40, 45, 50, 55, 60, 65, 70, 75, 80, 85, 90, 95, or about 100% surface area of the thermal reflector 112.

Beyond the materials of thermal reflector 112, the construction of thermal reflector 112 can impact the degree to which heat is reflected to second major surface 124. As shown in FIG. 1, thermal reflector 112 extends generally in the x-y direction. A major width of thermal reflector 112 can be substantially the same as a major width of support first major surface 124, a major diameter of bending ring 110, or both. However, in some embodiments, the major width of thermal reflector 112 can be less than the major width of support first major surface 124, the major diameter of bending ring 110, or both. This is shown in FIG. 1 and creates gap 126. Where present, gap 126 can be helpful to allow heat to escape assembly 100 during cooling. Gap 126 can also be helpful to prevent the outer edges of glass substrate 120 from overheating and therefore oversagging.

According to various embodiments, if the outer edges of glass substrate 120 are over heated a defect known as a “bathtub” effect can occur in glass substrate 120 during bending. The bathtub effect occurs where the outer edge is over-sagged or bent compared to the center region of glass substrate 120. The bathtub effect can be a particular problem for thinner glass. However, creating the temperature difference with gap 126 results in the outer edge being comparatively cooler than the center regions located directly underneath glass substrate 120. Therefore, the outer edges are less likely to over sag or bend and a more reliably shaped glass substrate 120 can be formed.

The thickness of thermal reflector 112 can be tuned to any suitable degree. For example a thickness of thermal reflector 112 can be in a range of from about 0.5 mm to about 25 mm, about 5 mm to about 10 mm, less than, equal to, or greater than about 0.5 mm, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, or about 25 mm. The thicker thermal reflector 112 is, the more likely heat is to be absorbed. As shown in FIG. 1, a thickness of thermal reflector 112, measured in the z-direction is substantially constant along the x-direction and the y-direction. However, in further embodiments it is possible for the thickness of thermal reflector 112, measured in the z-direction to be variable along the x-direction and the y-direction. Having a variable thickness in thermal reflector can be helpful in tuning the degree to which heat is reflected to specific locations on second major surface 124 of glass substrate 120.

As shown in FIG. 1, thermal reflector 112 is a continuous structure. However, in further embodiments it is possible for thermal reflector 112 to include one or more perforations extending at least partially therethrough. Adding the one or more perforations can be helpful to selectively allow heat to pass through reflector 112 and therefore not reflect to second major surface 124 of glass substrate 120. The degree to which heat can pass through an individual perforation can be the result of the size of the individual perforation (e.g., a major width or a major diameter). The size of the one or more perforations can individually be in a range of from about 2 mm to about 10 mm, about 4 mm to about 6 mm, less than, equal to, or greater than about 2 mm, 2.5, 3, 3.5, 4, 4.5, 5, 5.5, 6, 6.5, 7, 7.5, 8, 8.5, 9, 9.5, or about 10 mm. Moreover, the one or more perforations can individually account for about 5 vol % to about 95 vol % of the thermal reflector 112, about 10 vol % to about 70 vol %, about 40 vol % to about 60 vol %, less than, equal to, or greater than about 5 vol %, 10, 15, 20, 25, 30, 35, 40, 45, 50, 55, 60, 65, 70, 75, 80, 85, 90, or about 95 vol %. A cross sectional geometry of any one of the perforations can substantially conform to a circular shape or polygonal shape. Examples of suitable circular shapes can include an elongated or non-elongated circular shape. Examples of suitable polygonal shapes include a triangular shape, a quadrilateral shape, a pentagonal shape, a hexagonal shape, or any higher order polygonal shape.

FIG. 1, further shows thermal absorber 114, which is located above the support first surface 104 along the z-direction and below thermal reflector 112. Thermal absorber can function to absorb heat that may reflect from support 102 thermal reflector 112 or any other component. Because thermal absorber 114 is able to absorb heat, it can be used to control the amount of heat that is able to be reflected to second major surface 124 of glass substrate 120. Moreover, to the extent that heat is reflected from support 102 to second major surface 124 of glass substrate 120, thermal absorber 114 is able to distribute heat evenly to second major surface 124. The properties of thermal absorber 114 are a function, at least in part, of the material(s) and construction of thermal absorber 114.

According to various embodiments of the present disclosure, thermal absorber 114 can be formed from any thermally absorbent material. For example, thermal absorber 114 can include stainless steel, carbon steel, a refractory metal, or combinations thereof. Suitable examples of stainless steel grades can include SS 304, SS 309, SS 316, SS 347, and SS 405. Suitable examples of nickel alloys include Inconel alloys such as Inconel 600, Inconel 617, Inconel 625, Inconel 690, Inconel 718, and Inconel X-750. Further examples of suitable metals include alloys of a refractory metal such as a molybdenum alloy, tungsten alloy, niobium alloy, tantalum alloy, rhenium alloy, or a combination thereof.

Beyond the materials of thermal absorber 114, the construction of thermal absorber 114 can impart the degree to which heat is absorbed. As shown in FIG. 1, thermal absorber 114 extends generally in the x-y direction. A major width of thermal absorber 114 can be substantially the same as a major width of support first major surface 104, a major diameter of bending ring 110, or both. However, in some embodiments, the major width of thermal absorber 114 can be less than the major width of support first major surface 104, the major diameter of bending ring 110, or both.

The thickness of thermal absorber 114 can be tuned to any suitable degree. For example, a thickness of thermal absorber 114 can be in a range of from about 3 mm to about 12 mm, about 6 mm to about 8 mm, less than, equal to, or greater than about 3 mm, 3.5, 4, 4.5, 5, 5.5, 6, 6.5, 7, 7.5, 8, 8.5, 9, 9.5, 10, 10.5, 11, 11.5, or about 12 mm. The thicker thermal absorber 114 is, the more likely heat is to be absorbed. As shown in FIG. 1, a thickness of thermal absorber 114, measured in the z-direction is substantially constant along the x-direction and the y-direction. However, in further embodiments it is possible for the thickness of thermal absorber 114, measured in the z-direction to be variable along the x-direction and the y-direction. Having a variable thickness in thermal reflector can be helpful in tuning the degree to which heat is reflected to specific locations on second major surface 124 of glass substrate 120 or to thermal reflector 112.

As shown in FIG. 1, thermal absorber 114 is a continuous structure. However, in further embodiments it is possible for thermal absorber 114 to include one or more perforations extending at least partially therethrough. Adding the one or more perforations can be helpful to selectively allow heat to pass through absorber 114 and to therefore pass from support 102 to thermal reflector 112 or to second major surface 124 of glass substrate. The degree to which heat can pass through an individual perforation can be the result of the size of the individual perforation (e.g., a major width or a major diameter). The size of the one or more perforations can individually be in a range of from about 2 mm to about 10 mm, about 4 mm to about 6 mm, less than, equal to, or greater than about 2 mm, 2.5, 3, 3.5, 4, 4.5, 5, 5.5, 6, 6.5, 7, 7.5, 8, 8.5, 9, 9.5, or about 10 mm. Moreover, the one or more perforations can individually account for about 5 vol % to about 95 vol % of the absorber 114, about 10 vol % to about 70 vol %, about 40 vol % to about 60 vol %, less than, equal to, or greater than about 5 vol %, 10, 15, 20, 25, 30, 35, 40, 45, 50, 55, 60, 65, 70, 75, 80, 85, 90, or about 95 vol %. A cross sectional geometry of any one of the perforations can substantially conform to a circular shape or polygonal shape. Examples of suitable circular shapes can include an elongated or non-elongated circular shape. Examples of suitable polygonal shapes include a triangular shape, a quadrilateral shape, a pentagonal shape, a hexagonal shape, or any higher order polygonal shape.

As shown in FIG. 1, thermal reflector 112 and thermal absorber 114 are stationary structures. However, in further embodiments, it may be possible for either one, or both, of thermal reflector 112 or thermal absorber 114 to be movable in the x-, y-, and/or z-directions. Moving either thermal reflector 112 or thermal absorber 114 can help to tune the amount of heat that is delivered to a specific area of second major surface 124 of glass substrate 120. According to various embodiments, thermal reflector 112 or thermal absorber 114 can be moved manually or automatically based on a program executed by a controller that receives input data from temperatures measured on second major surface 124 of glass substrate 120.

As shown in FIG. 1, assembly 100 includes both thermal reflector 112 and thermal absorber 114. However, in some embodiments it may be possible for assembly 100 to only include one of thermal reflector 112 or thermal absorber 114. In embodiments where assembly 100 only includes thermal reflector 112, it may be desirable for the major width of thermal reflector 112 to be substantially the same as that of first major surface 104 of support 102 so that thermal radiation reflecting from first major surface 104 is blocked to some degree by thermal reflector 112. In embodiments where assembly 100 only includes thermal absorber 114, it may be desirable for the major width of thermal absorber 114 to be substantially the same as that of first major surface 104 of support 102 so that thermal radiation reflecting from first major surface 104 is absorbed or at least made substantially uniform before being reflected to second major surface 124 of glass substrate 120.

According to various embodiments, assembly 100 can be used in conjunction with a method of bending glass substrate 120. The method can include actively heating first major surface 122 of glass substrate 120 and passively heating opposed second major surface 124 of glass substrate 120. Heat can be actively provided by active heating element 116. The heat generated by active heating element 116 can be in a range of from about 600° C. to about 2000° C., about 700° C. to about 750° C., less than, equal to, or greater than about 600, 605, 610, 615, 620, 625, 630, 635, 640, 645, 650, 655, 660, 665, 670, 675, 680, 685, 690, 695, 700, 705, 710, 715, 720, 725, 730, 735, 740, 745, 750, 755, 760, 765, 770, 775, 780, 785, 790, 795, 800, 805, 810, 820, 825, 830, 835, 840, 845, 850, 855, 860, 865, 870, 875, 880, 885, 890, 895, 900, 905, 910, 915, 920, 925, 930, 935, 940, 945, 950, 955, 960, 965, 970, 975, 980, 985, 990, 995, 1000, 1005, 1010, 1015, 1020, 1025, 1030, 1035, 1040, 1045, 1050, 1055, 1060, 1065, 1070, 1075, 1080, 1085, 1090, 1095, 1100, 1105, 1110, 1115, 1120, 1125, 1130, 1135, 1140, 1145, 1150, 1155, 1160, 1165, 1170, 1175, 1180, 1185, 1190, 1195, 1200, 1205, 1210, 1215, 1220, 1225, 1230, 1235, 1240, 1245, 1250, 1255, 1260, 1265, 1270, 1275, 1280, 1285, 1290, 1295, 1300, 1305, 1310, 1315, 1320, 1325, 1330, 1335, 1340, 1345, 1350, 1355, 1360, 1365, 1370, 1375, 1380, 1385, 1390, 1395, 1400, 1405, 1410, 1415, 1420, 1425, 1430, 1435, 1440, 1445, 1450, 1455, 1460, 1465, 1470, 1475, 1480, 1485, 1490, 1495, 1500, 1505, 1510, 1515, 1520, 1525, 1530, 1535, 1540, 1545, 1550, 1555, 1560, 1565, 1570, 1575, 1580, 1585, 1590, 1595, 1600, 1605, 1610, 1615, 1620, 1625, 1630, 1635, 1640, 1645, 1650, 1655, 1660, 1665, 1670, 1675, 1680, 1685, 1690, 1695, 1700, 1705, 1710, 1715, 1720, 1725, 1730, 1735, 1740, 1745, 1750, 1755, 1760, 1765, 1770, 1775, 1780, 1785, 1790, 1795, 1800, 1805, 1810, 1820, 1825, 1830, 1835, 1840, 1845, 1850, 1855, 1860, 1865, 1870, 1875, 1880, 1885, 1890, 1895, 1900, 1905, 1910, 1915, 1920, 1925, 1930, 1935, 1940, 1945, 1950, 1955, 1960, 1965, 1970, 1975, 1980, 1985, 1990, 1995, or about 2000° C.

After heat passes through glass substrate 120 second major surface 124 of glass substrate 120 is passively heated by reflecting heat from thermal reflector 112. The heat reflected by thermal reflector 112 may be substantially the same temperature as the heat provided by active heater element 116. However, in some embodiments the heat may be less than the same temperature as the heat provided by active heater element 116.

The heat reflected by thermal reflector 112 can be uniformly or symmetrically distributed about second major surface 124 of glass substrate 120. Alternatively, different amounts of heat can be selectively delivered to predetermined locations of second major surface 124 of glass substrate 120. For example, a greater amount of heat can be delivered to a central region of second major surface 124 of glass substrate 120 than to a peripheral region of second major surface 124 of glass substrate 120. For example, the peripheral region can heated to a temperature that is in a range of from about 5° C. to about 100° C. lower than a central region of glass substrate 120, about 30° C. to about 60° C. lower, less than, equal to, or greater than about 5° C., 10, 15, 20, 25, 30, 35, 40, 45, 50, 55, 60, 65, 70, 75, 80, 85, 90, 95, or about 100° C. lower. As stated herein creating this temperature difference can be helpful to mitigate the bathtub effect.

The glass can be bent by gravity once the heat is applied. Alternatively, a press can be applied to first major surface 122 of glass substrate 120. After glass substrate 120 is bent to a suitable degree, glass substrate 120 can be cooled to room temperature. This can be accomplished by ceasing to produce heat from active heating elements 116 or by moving support 102 away from active heating elements 116. Support 102 can be moved using wheels 108. Support 102 can also have a skid attached thereto to facilitate movement.

By using assembly 100, the degree to which glass substrate 120 is bent can be directly controlled. Moreover, in embodiments in which glass substrate 120 is a multi-ply structure and the ply that forms first major surface 122 is comparatively thin compared to the other ply assembly 100 can be used to carefully apply selected levels of heat to the thinner ply. Thus assembly 100 can be used for bending hybrid glass substrates 120 that have plies differing by composition or asymmetric glass substrates 120 that have plies differing by thickness.

Assembly 100 can be used in conjunction with an existing active heating component 116. For example, a furnace does not have to be specifically designed to accommodate support 102. As a result, as long as a furnace or other structure capable of generating heat can accommodate support 102, support 102 can be used to accomplish bending of glass substrate 120 in accordance with the methods described herein.

Bent glass substrates 120 formed according to the methods described herein can be incorporated into a vehicle such as an automobile or aerospace vehicle. According to various embodiments, vehicles can include a body defining an interior and an opening in communication with the interior. Bent glass substrate 120 can be located in the opening. According to various embodiments, bent glass substrate 120 can be a windshield, side window, back window, moonroof, or any other vehicle component.

### EXAMPLES

Various embodiments of the present disclosure can be better understood by reference to the following Examples which are offered by way of illustration. The present disclosure is not limited to the Examples given herein.

### Example 1

### Computer Simulations

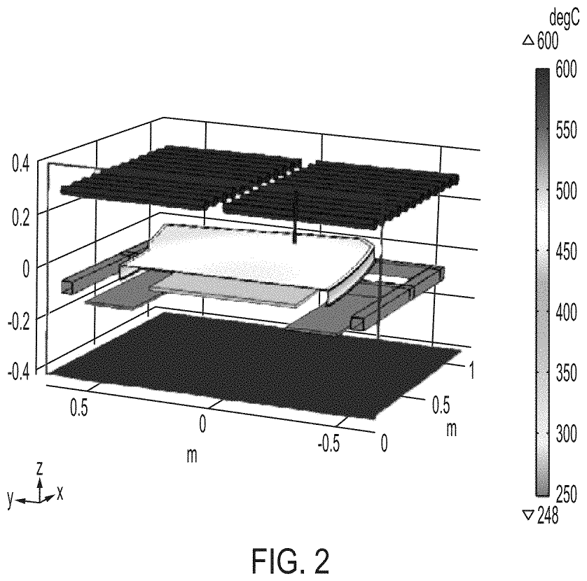

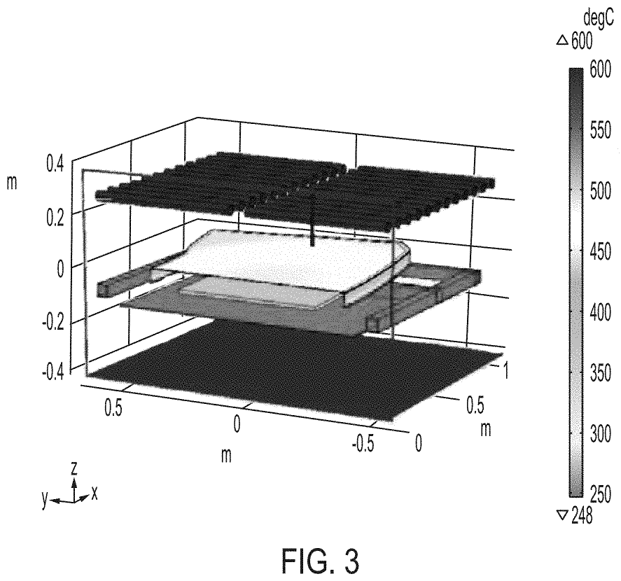

To study the effect of the assemblies described herein, computer simulations were conducted. Error! Reference source not found. and 3 show two surface-to-surface-radiation models of the bending stations of a Vetro Tool™ furnace used to quantify the impact of adding a refractory thermal reflector and a steel plate thermal absorber below it. All surfaces were considered diffuse and all objects, including the glass, are modeled as opaque (not transparent). Two rows of cylindrical heaters are visible at the top of the furnace. The ring supporting the preform and the frame supporting the ring were introduced in the model as floated structures. The remainder of the steel was introduced with a steel plate that was either C-shaped (FIG. 2) or uniform (FIG. 3). A refractory thermal reflector shaped like the preform but of smaller size is below the glass but above the frame. FIGS. 2 and 3 show the initial condition chosen at the beginning of the first bending station.

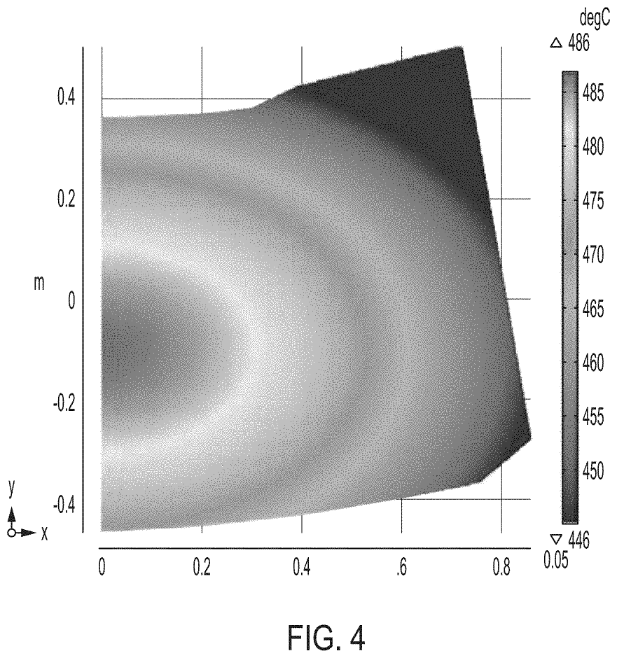

Due to its high thermal inertia the steel was much colder than the glass. Since the refractory thermal reflector traveled with the glass it was assumed that in previous stations it heated up to a temperature intermediate between that of the glass and steel. The initial steel and glass temperatures were chosen to match experimental measurements. In particular for the glass, only locations at the central top and bottom and at a side top of the glass were measured. Based on these point measurements a parabolic profile as seen in FIG. 4 was constructed.

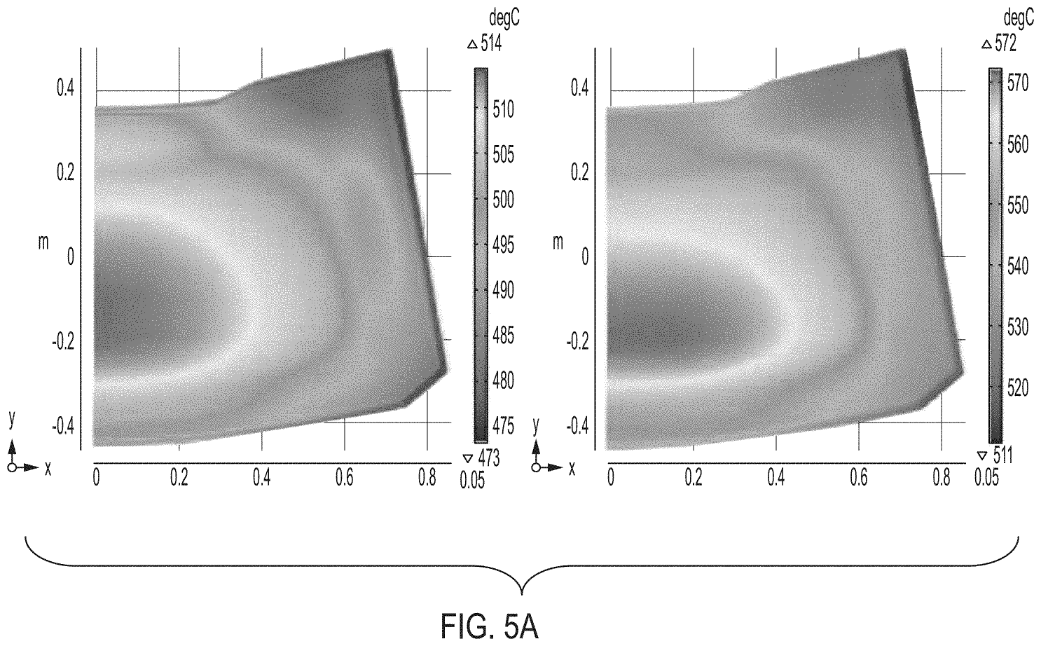

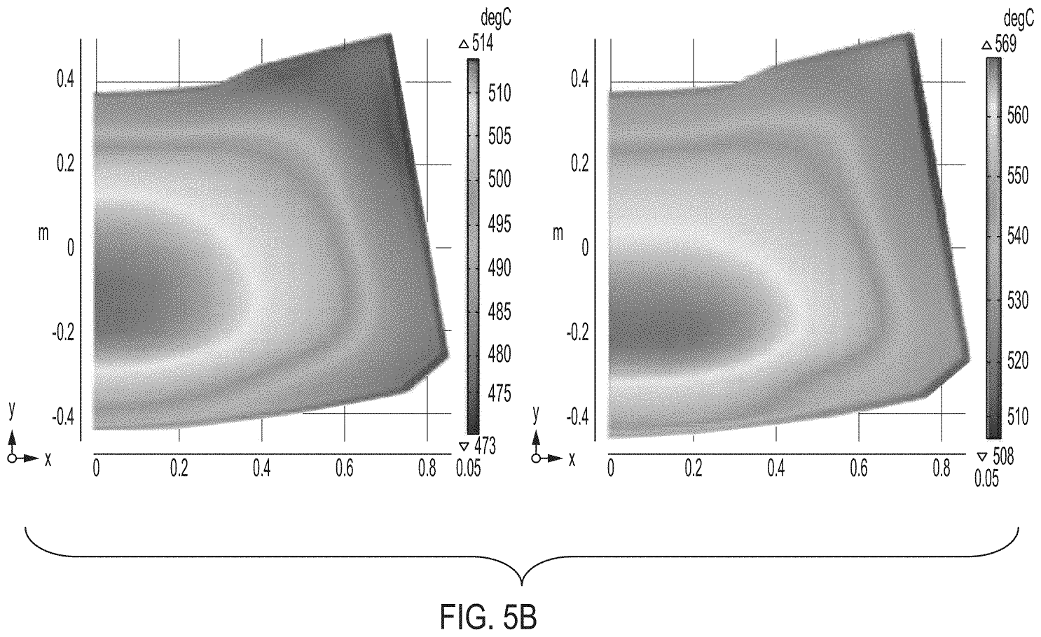

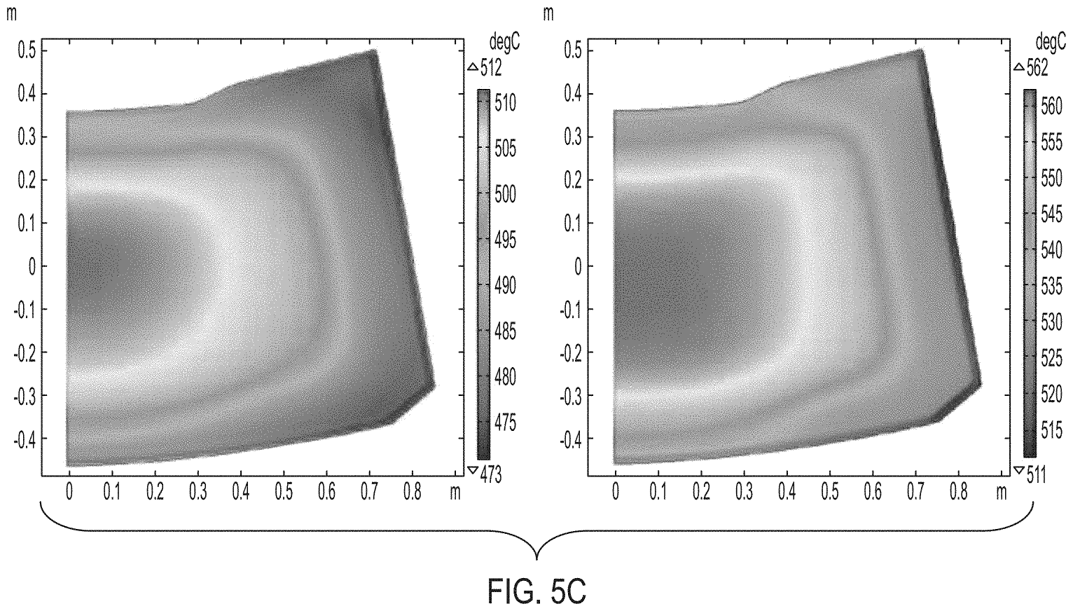

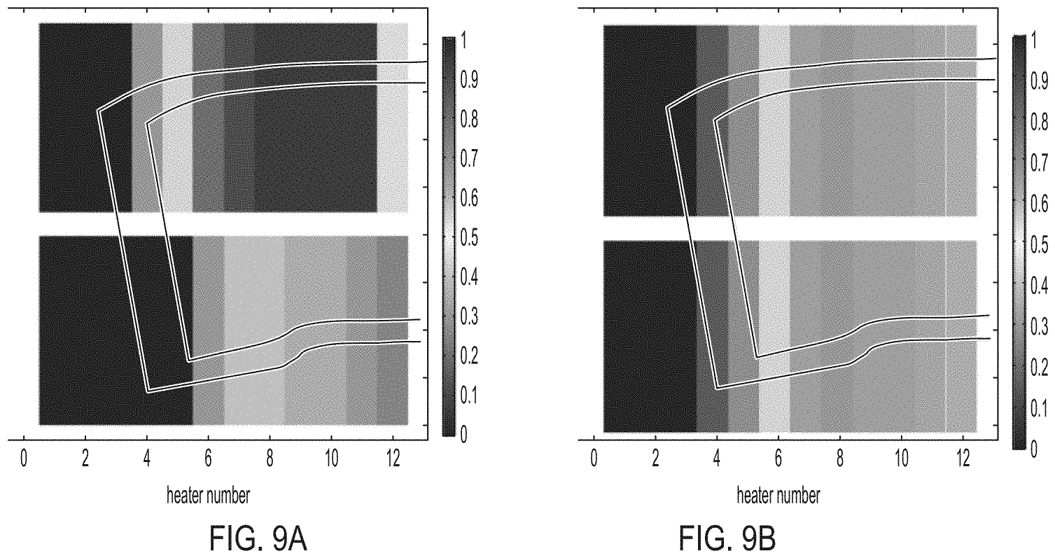

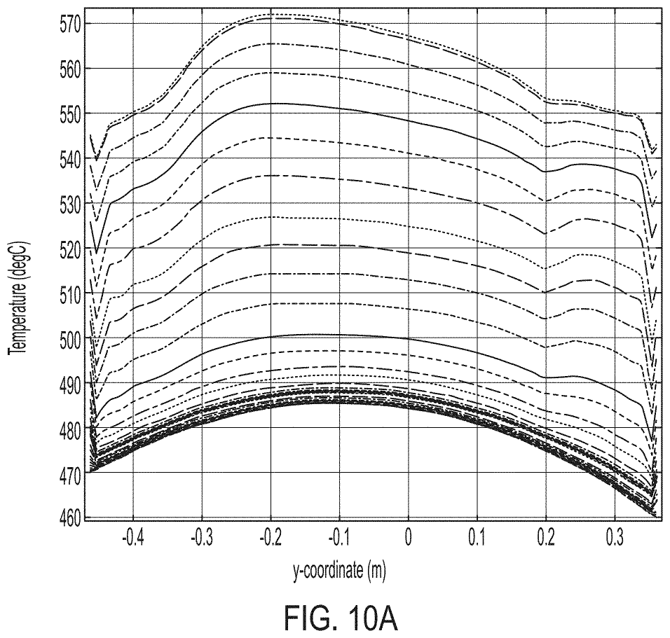

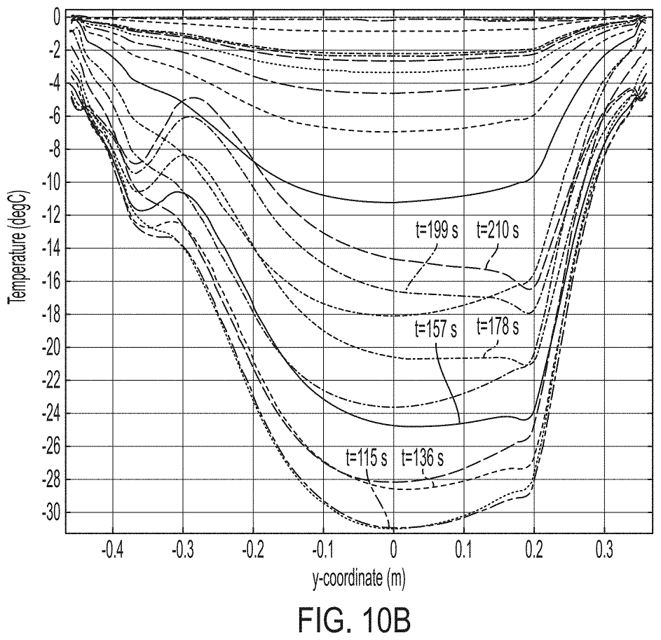

Error! Reference source not found. A-5C shows the temperature profiles at the top of the glass at the end of the first and last bending stations. The refractory thermal reflector as shown helped raise the temperature at the center of the glass. The contour of the refractory was visible in all cases, but in the temperature gradient region between the ring and the center the profile was not as clean when the steel plate did not completely cover the space below the glass (See FIG. 5A) as compared to examples when it does (See FIGS. 5A and 5B). The difference between FIGS. 5B and 5C was the power distribution of the heaters which are shown in FIG. 9. For FIG. 5B the design of the power distribution was to provide optimum heating for co-bending in the absence of the refractory thermal reflector. Thus, considerably more heating was provided at the cowl than at the roof. However, as shown, the refractory was effective at heating to a degree that the glass at the cowl side became hotter than the roof side. FIG. 5C shows that by adopting the same power distribution for both rows of active heaters, the bias was eliminated. That is, just one row of heaters sufficed when the refractory reflector and steel plate were used.

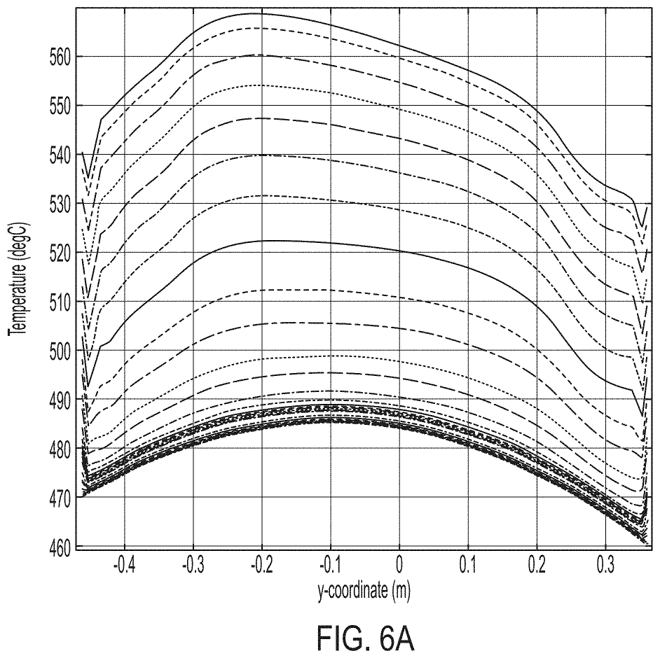

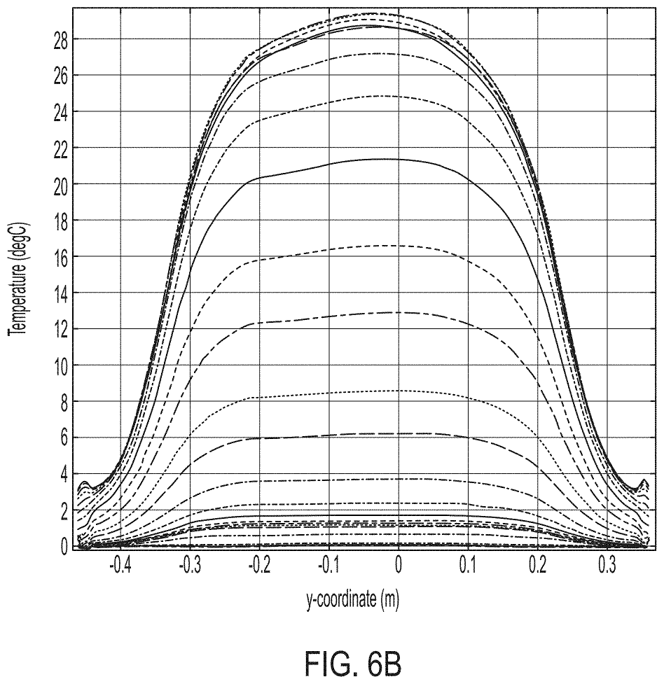

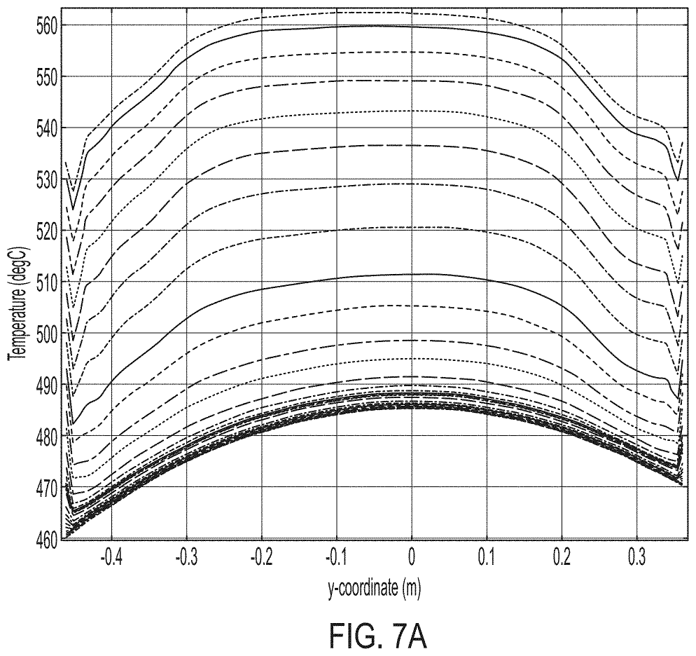

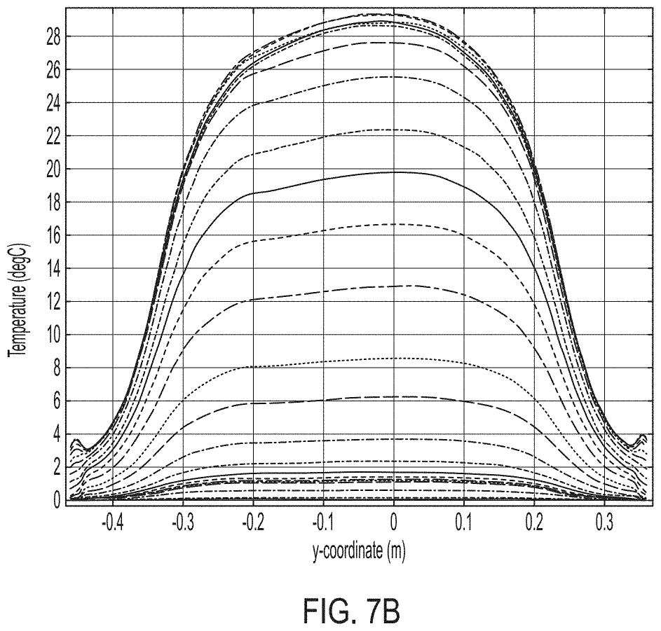

Error! Reference source not found. A and 6B show the time evolution along the roof to cowl centerline at the top of the glass with the refractory thermal reflector (FIG. 6A) and the difference of the solutions with and without refractory thermal reflector (FIG. 6B) for the case of the uniform steel plate thermal absorber and with different power distribution among the two rows of heaters (Shown in FIG. 9, baseline). The refractory thermal reflector helped to heat up the center of the glass in a desirable manner, with the difference with and without refractory thermal reflector being a quasi-symmetric distribution with maximum at the center. The maximum temperatures shown at FIG. 6A did not occur at the center of the glass because of the uneven distribution of power between the two rows (shown at FIG. 9 baseline). Error! Reference source not found.A and 7B show that when the power was distributed evenly among the two row of heaters the temperature profile became almost symmetrical while the difference plot kept its overall symmetrical shape, this showed that the refractory worked better with even heating at both rows.

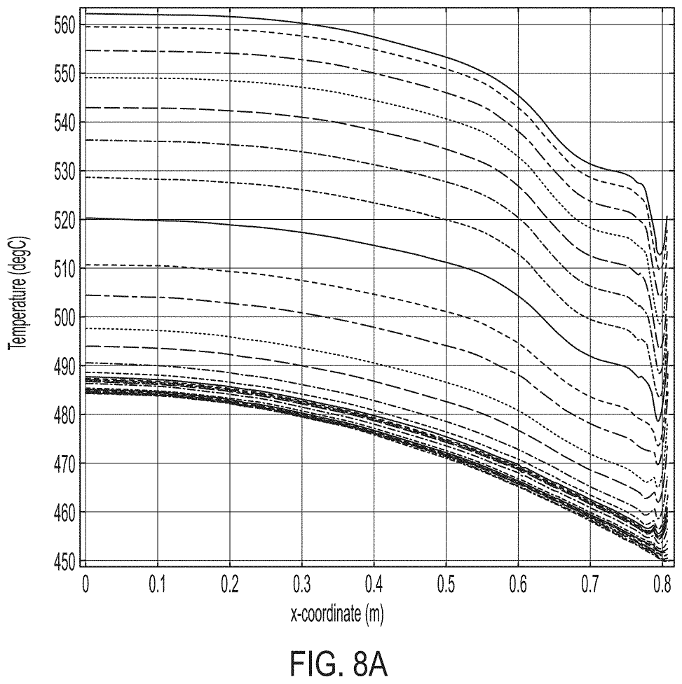

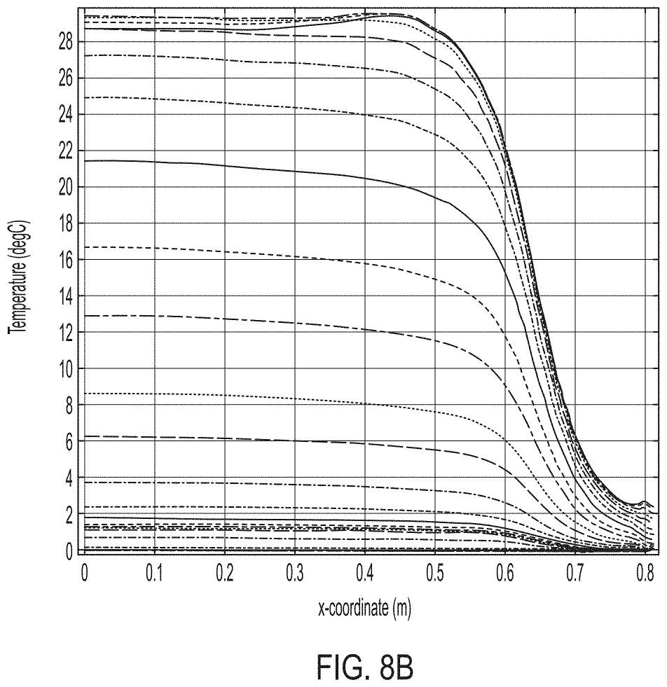

Error! Reference source not found. that the time evolution from center to pillar at the top of the glass with the refractory thermal reflector (FIG. 8A) and show the difference of the solutions with and without refractory thermal reflector (FIG. 8B) for the case of the uniform steel plate and with different power distribution among the two rows of heaters. As shown, the center of the glass was hotter than the edges as desired. In this direction the thermal gradient between center and edge was controlled not only by the gap but by the distribution of power to the heaters. Since the power of the heaters on the pillar side was smaller than that on the center as can be seen in FIGS. 9A and 9B, the region with a thermal gradient was larger in the center to pillar than in the center to cowl/roof. This suggested that the gap between refractory thermal reflector and ring could be used as the main control variable of the gradient and a more uniform distribution of power in the pillar to pillar direction could be adopted.

Error! Reference source not found.A and 10B show that when the steel plate thermal absorber did not completely cover the region below the glass, the refractory thermal reflector introduced a non-monotonic behavior with the refractory thermal reflector, which helped cool the glass for the first 115 seconds simulated and to heat it up later.

### Example 2

### Wilt Furnace Experiments on Square Glass

The objective of the experiments was to verify that a refractory thermal reflector could be used as a reflector to heat up the center of the glass in a configuration as described herein. The experiments were conducted in the Wilt™ furnace. A single ply of 300 mm×300 mm×2.1 mm soda lime glass was mounted on a steel frame. The frame height was 300 mm×300 mm×16 mm. The steel plate was located at the bottom of frame. The remainder of the oven floor and walls was covered by white insulation. Radiating heating elements were located above the glass. Experiments were conducted with and without the refractory thermal reflector shown below the glass. A 250 mm×250 mm×4 mm Duraboard™ refractory thermal reflector was located 19 mm below the glass. Sheathed thermocouples of 0.5 mm outside diameter were used to measure temperature at the center of the glass, both top and bottom surfaces, half an inch from the edge at the top center of the glass, and the center top surface of the steel plate. It was known that the temperature measured by the thermocouple is influenced by the radiation absorbed by the thermocouple body and the transport by conduction to the tip where the thermocouple measuring joint is.

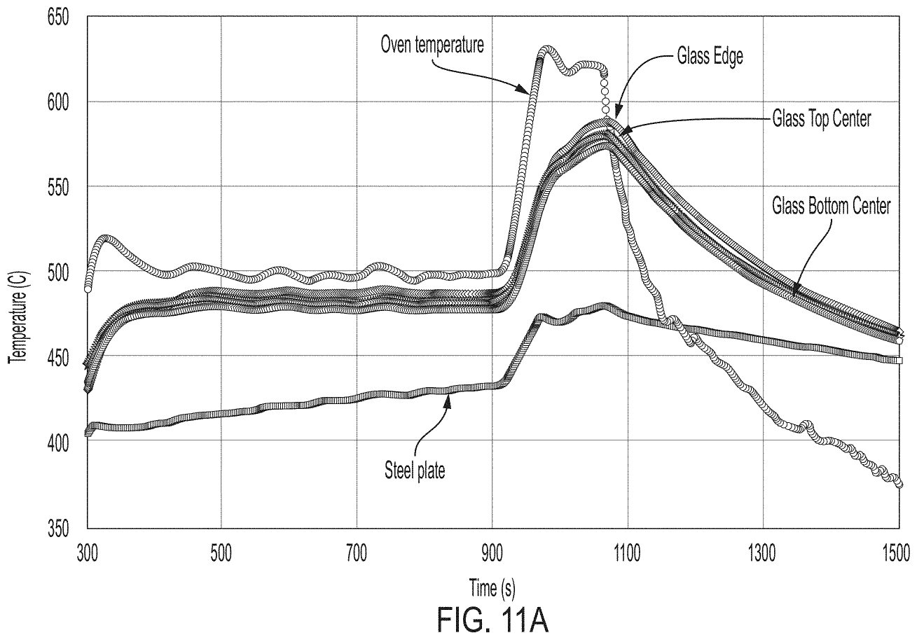

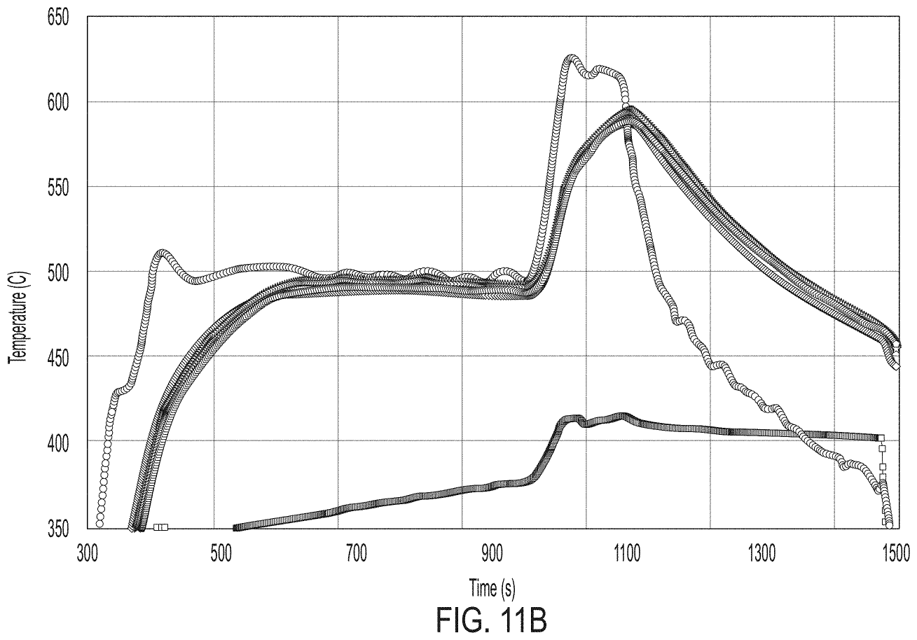

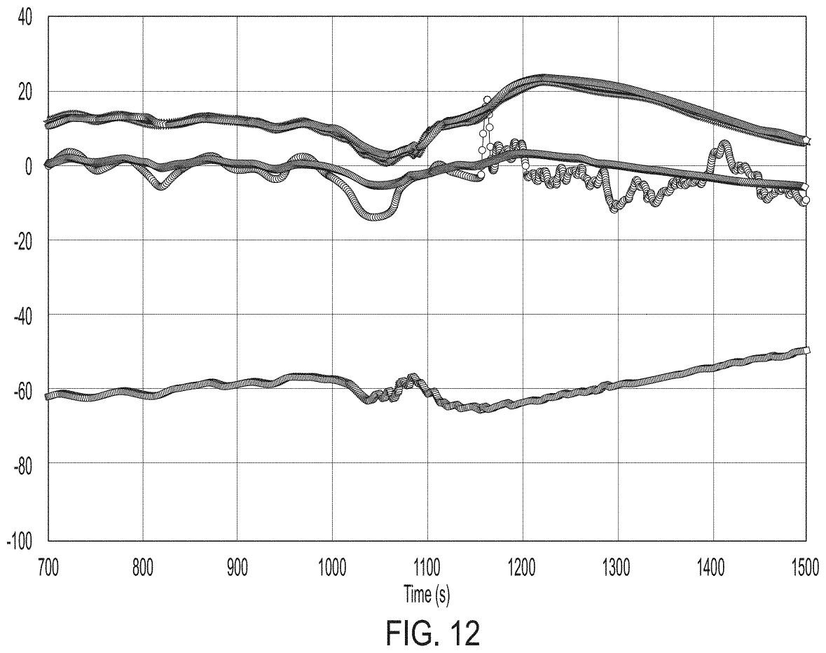

The thermocouples were attached with cement and flattened against the glass as this is the best practice to reduce the systematic error just mentioned. The oven temperature was measured by a thermocouple at the center of the oven. To ensure that the temperature of the steel has reached a quasi-steady state, several power cycles were implemented before the one used for measurement. As can be seen in FIGS. 11A and 11B (grey line) each cycle included quickly taking the oven to about 500° C., staying at that temperature for about 500 s, then quickly raising the temperature to about 620° C. and staying at that temperature for about 100 s before shutting of power completely. The time offset between the cases with and without refractory was due to the manual activation of the recording system for all temporaries but that of the furnace. Once this difference offset was corrected for, the difference of temperatures with and without refractory can be seen in FIG. 12.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

### Additional Embodiments

The following exemplary embodiments are provided, the numbering of which is not to be construed as designating levels of importance:

Embodiment 1 provides an assembly for bending glass, the assembly comprising:

a support extending along an x-direction and a y-direction and comprising a support first major surface and opposed second major surface;

a bending ring attached to and extending vertically along a z-direction from the support first major surface substantially along an outer perimeter of the support first major surface; and

a passive heat element disposed between the support first major surface and a top end of the bending ring.

Embodiment 2 provides the assembly of Embodiment 1, wherein the support, the bending ring, or both comprises a metal, a ceramic, or a composite thereof.

Embodiment 3 provides the assembly of Embodiment 2, wherein the metal comprises stainless steel.

Embodiment 4 provides the assembly of any one of Embodiments 1-5, wherein the bending ring and the support comprise the same material.

Embodiment 5 provides the assembly of any one of Embodiments 1-6, wherein the passive heat element comprises a thermal reflector.

Embodiment 6 provides the assembly of Embodiment 7, wherein thermal reflector is located above the support first surface along the z-direction.

Embodiment 7 provides the assembly of any one of Embodiments 7 or 8, wherein the thermal reflector extends generally in the x-y direction.

Embodiment 8 provides the assembly of Embodiment 9, wherein a major width of the thermal reflector is substantially the same as a major width of the support first major surface, a major diameter of the bending ring, or both.

Embodiment 9 provides the assembly of Embodiment 9, wherein a major width of the thermal reflector is less than a major width of the support first major surface, a major diameter of the bending ring, or both.

Embodiment 10 provides the assembly of any one of Embodiments 7-11, wherein a thickness of the thermal reflector measured in the z-direction is substantially constant along the x-direction and the y-direction.

Embodiment 11 provides the assembly of any one of Embodiments 7-12, wherein a thickness of the thermal reflector measured in the z-direction is variable along the x-direction and the y-direction.

Embodiment 12 provides the assembly of any one of Embodiments 7-13, wherein the thermal reflector comprises one or more perforations.

Embodiment 13 provides the assembly of any one of Embodiments 7-14, wherein the thermal reflector comprises a continuous structure.

Embodiment 14 provides the assembly of any one of Embodiments 7-15, wherein the thermal reflector comprises a thermally reflective material chosen from a metal, a ceramic, or a mixture thereof.

Embodiment 15 provides the assembly of Embodiment 16, wherein the metal comprises gold, aluminum, stainless steel, a nickel alloy, or a combination thereof.

Embodiment 16 provides the assembly of any one of Embodiments 16 or 17, wherein the ceramic comprises barium, boron, silicon, titanium, yttrium, zinc, aluminum, or a combination thereof.

Embodiment 17 provides the assembly of any one of Embodiments 7-, wherein the thermal reflector further comprises a thermally reflective coating disposed thereon.

Embodiment 18 provides the assembly of Embodiment 17, wherein the thermally reflective coating is dispersed over about 20% to about 100% surface area of the thermal reflector.

Embodiment 19 provides the assembly of any one of Embodiments 17 or 18, wherein the thermally reflective coating is dispersed over about 50% to about 100% surface area of the thermal reflector.

Embodiment 20 provides the assembly of any one of Embodiments 17-19, wherein the thermally reflective coating is dispersed over about 50% to about 100% surface area of the thermal reflector.

Embodiment 21 provides the assembly of any one of Embodiments 17-20, wherein the thermally reflective coating is dispersed over about 70% to about 90% surface area of the thermal reflector.

Embodiment 22 provides the assembly of any one of Embodiments 17-21, wherein the thermally reflective coating comprises gold.

Embodiment 23 provides the assembly of any one of Embodiments 1-22, wherein the passive heat element comprises a thermal absorber.

Embodiment 24 provides the assembly of Embodiment 23, wherein the thermal absorber is located above the support first surface along the z-direction.

Embodiment 25 provides the assembly of any one of Embodiments 23 or 24, wherein the thermal absorber extends generally in the x-y direction.

Embodiment 26 provides the assembly of Embodiment 25, wherein a major width of the thermal reflector is substantially the same as a major width of the support first major surface, a major diameter of the bending ring, or both.

Embodiment 27 provides the assembly of Embodiment 25, wherein a major width of the thermal reflector is less than a major width of the support first major surface, a major diameter of the bending ring, or both.

Embodiment 28 provides the assembly of any one of Embodiments 25-26, wherein a thickness of the thermal absorber measured in the z-direction is substantially constant along the x-direction and the y-direction.

Embodiment 29 provides the assembly of any one of Embodiments 25-28, wherein a thickness of the thermal absorber measured in the z-direction variable along the x-direction and the y-direction.

Embodiment 30 provides the assembly of any one of Embodiments 23-29, wherein the thermal absorber comprises a thermally absorbent material chosen from stainless steel, carbon steel, or combinations thereof.

Embodiment 31 provides the assembly of any one of Embodiments 28-32, wherein the thermal absorber comprises one or more perforations extending at least partially therethrough.

Embodiment 32 provides the assembly of Embodiment 31, wherein the one or more perforations individually have a diameter in a range of from about 2 mm to about 10 mm.

Embodiment 33 provides the assembly of any one of Embodiments 31 or 32, wherein the one or more perforations individually account for about 5 vol % to about 95 vol % of the thermal absorber.

Embodiment 34 provides the assembly of any one of Embodiments 23-30, wherein the thermal absorber comprises a continuous structure.

Embodiment 35 provides the assembly of any one of Embodiments 23-34, wherein the assembly comprises the thermal reflector and the thermal absorber.

Embodiment 36 provides the assembly of Embodiment 35, wherein the thermal absorber is located between the thermal reflector and the support first major surface.

Embodiment 37 provides the assembly of any one of Embodiments 35 or 36, wherein a major width of the thermal reflector is less than a major width of the support first major surface, a major diameter of the bending ring, or both.

Embodiment 38 provides the assembly of any one of Embodiments 35-37, wherein a major width of the thermal absorber is substantially the same as or greater than a major width of the thermal reflector.

Embodiment 39 provides the assembly of any one of Embodiments 1-38, further comprising an active heating element located above the bending ring along the z-direction.

Embodiment 40 provides the assembly of any one of Embodiments 1-39, further comprising a glass substrate in contact with the bending ring.

Embodiment 41 provides the assembly of Embodiment 40, wherein the glass substrate comprises a first major surface and an opposed second major surface and the second major surface is in contact with the bending ring.

Embodiment 42 provides the assembly of any one of Embodiments 40 or 41, wherein the glass substrate comprises a plurality of glass plies.

Embodiment 43 provides the assembly of Embodiment 42, wherein the plurality of glass plies comprises a first glass ply and a second glass ply.

Embodiment 44 provides the assembly of Embodiment 43, wherein a thickness the first glass ply and the second glass ply measured in the z-direction are substantially the same.

Embodiment 45 provides the assembly of Embodiment 43, wherein a thickness of the first glass ply and the second glass ply measured in the z-direction are different.

Embodiment 46 provides the assembly of any one of Embodiments 43-45, wherein the first glass ply and the second glass ply independently comprise soda-lime glass, aluminosilicate glass, a borosilicate glass, or a mixture thereof.

Embodiment 47 provides the assembly of any one of Embodiments 43-46, wherein a composition of the first ply and the second ply are substantially the same.

Embodiment 48 provides the assembly of any one of Embodiments 46-47, wherein a composition of the first ply and the second ply are substantially different.

Embodiment 49 provides the assembly of any one of Embodiments 40-48, wherein a thickness of the glass substrate, measured in the z-direction is in a range of from about 0.3 mm to about 5 mm.

Embodiment 50 provides the assembly of any one of Embodiments 40-49, wherein a thickness of the glass substrate, measured in the z-direction is in a range of from about 1.5 mm to about 3 mm.

Embodiment 51 provides the assembly of any one of Embodiments 1-50, wherein the passive heat element is movable in the z-direction.

Embodiment 52 provides a method of bending the glass substrate of any one of Embodiments 40-51, the method comprising:

actively heating the first major surface of the glass substrate; and

passively heating the opposed second major surface of the glass substrate.

Embodiment 53 provides the method of Embodiment 52, wherein the second major surface of the glass substrate is passively heated by reflecting heat from the passive heat element of the assembly, to the second major surface of the glass substrate.

Embodiment 54 provides the method of any one of Embodiments 52 or 53, wherein different amounts of heat are selectively delivered to predetermined locations of the second major surface of the glass substrate.

Embodiment 55 provides the method of any one of Embodiments 52-54, wherein a greater amount of heat is delivered to a central region of the second major surface of the glass substrate than to a peripheral region of the second major surface of the glass substrate.

Embodiment 56 provides the method of any one of Embodiments 52-55, wherein the heat is symmetrically distributed about the second major surface of the glass substrate.

Embodiment 57 provides the method of any one of Embodiments 52-56, further comprising applying a press to the first major surface of the glass substrate.

Embodiment 58 provides the method of any one of Embodiments 52-57, further comprising cooling the glass.

Embodiment 59 provides the method of any one of Embodiments 52-58, where transmission of heat from the support to through the passive heating element is substantially blocked.

Embodiment 60 provides a bent glass article formed according to the method of any one of Embodiments 52-59.

Embodiment 61 provides a vehicle comprising:

a body defining an interior and an opening in communication with the interior; and

the glass substrate of any one of Embodiments 40-51 or 60, disposed in the opening.

What is claimed is:

1. An assembly for bending glass, the assembly comprising:
a support extending along an x-direction and a y-direction and comprising a support first major surface and opposed second major surface;
a bending ring attached to and extending vertically along a z-direction from the support first major surface substantially along an outer perimeter of the support first major surface; and
a passive heat element disposed between the support first major surface and a top end of the bending ring.

2. The assembly of claim 1, wherein the passive heat element comprises a thermal reflector.

3. The assembly of claim 2, wherein thermal reflector is located above the support first surface along the z-direction.

4. The assembly of claim 2, wherein a major width of the thermal reflector is less than a major width of the support first major surface, a major diameter of the bending ring, or both.

5. The assembly of claim 2, wherein a thickness of the thermal reflector measured in the z-direction is substantially constant along the x-direction and the y-direction.

6. The assembly of claim 2, wherein the thermal reflector comprises one or more perforations.

7. The assembly of claim 2, wherein the thermal reflector comprises a thermally reflective material chosen from a metal, a ceramic, or a mixture thereof.

8. The assembly of claim 7, wherein the metal comprises gold, aluminum, stainless steel, a nickel alloy, or a combination thereof.

9. The assembly of claim 7, wherein the thermal reflector further comprises a thermally reflective coating disposed thereon.

10. The assembly of claim 1, wherein the passive heat element comprises a thermal absorber.

11. The assembly of claim 10, wherein the thermal absorber is located above the support first surface along the z-direction.

12. The assembly of claim 10, wherein a major width of the thermal absorber is substantially the same as a major width of the support first major surface, a major diameter of the bending ring, or both.

13. The assembly of claim 2, wherein the passive heat element is a first passive heat element and comprises the thermal reflector and the assembly further includes a second passive heat element and comprises a thermal absorber and the thermal absorber is located between the thermal reflector and the support first major surface.

14. The assembly of claim 1, further comprising a glass substrate in contact with the bending ring.

15. The assembly of claim 14, wherein the glass substrate comprises a first major surface and an opposed second major surface and the second major surface is in contact with the bending ring.

16. The assembly of claim 14, wherein the glass substrate comprises a plurality of glass plies.

17. A method of bending a glass substrate, the method comprising:
actively heating the first major surface of the glass substrate; and
passively heating the opposed second major surface of the glass substrate.

18. The method of claim 17, wherein the second major surface of the glass substrate is passively heated by reflecting heat from the passive heat element of the assembly, to the second major surface of the glass substrate.

19. The method of claim 17, wherein different amounts of heat are selectively delivered to predetermined locations of the second major surface of the glass substrate.

20. The method of claim 17, wherein a greater amount of heat is delivered to a central region of the second major surface of the glass substrate than to a peripheral region of the second major surface of the glass substrate.
